(19) United States
(12) Patent Application Publication
(10) Pub. No.: US 2006/0134362 A1
(43) Pub. Date: Jun. 22, 2006

(54) Optically clear pressure sensitive adhesive

(75) Inventors: Ying-Yuh Lu, Woodbury, MN (US); David Scott Thompson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/015,406

(22) Filed: Dec. 17, 2004

(51) Int. Cl. B32B 33/00

(52) U.S. Cl. 428/40.1; 428/343

(57) ABSTRACT

An optically clear pressure sensitive adhesive film includes a pressure sensitive adhesive formed by polymerizing a (C₁-C₈)alkyl (meth)acrylate monomer, and a plurality of surface modified nanoparticles dispersed in the pressure sensitive adhesive. Methods of forming optically clear pressure sensitive adhesive films are also disclosed.

### BACKGROUND

The present invention generally relates to optically clear pressure sensitive adhesives (PSAs) that include nanoparticles. The present invention more particularly relates to optically clear PSAs that include nanoparticles for use with optical elements.

Optically clear PSAs are used to adhere optical films to optical elements such as, for example, glass elements or polymeric elements. Optically clear PSAs have been utilized in a variety of applications such as LCD displays. Some PSAs exhibit poor heat and humidity resistance. These adhesives can delaminate under conditions of high heat and humidity. Delamination of the optical film from the PSA and/or from the optical element from the PSA which may lead to undesirable changes in the optical properties of the optical element.

There is a need for an optically clear pressure sensitive adhesive that can be used to adhere optical films onto optical elements while maintaining high temperature and high humidity stability.

### SUMMARY

The present application discloses optically clear pressure sensitive adhesives (PSAs) that include nanoparticles. The disclosed optically clear PSAs exhibit improved environmental stability and/or peel adhesion.

In one embodiment, an optically clear pressure sensitive adhesive film includes a pressure sensitive adhesive formed by polymerizing a (C₁-C₈)alkyl (meth)acrylate monomer, and a plurality of surface modified nanoparticles dispersed in the pressure sensitive adhesive.

In a further embodiment, a pressure sensitive adhesive article includes a substrate, a pressure sensitive adhesive film formed by polymerizing a (C₁-C₈)alkyl (meth)acrylate monomer, disposed on the substrate, and a plurality of surface modified nanoparticles disposed in the pressure sensitive adhesive. Exemplary pressure sensitive adhesive films have a haze value in a range of 0 to 5%.

In another embodiment, a method of forming a pressure sensitive adhesive film including the steps of polymerizing a (C₁-C₈)alkyl (meth)acrylate monomer to form a pressure sensitive adhesive composition, and combining the pressure sensitive adhesive composition with a plurality of surface modified nanoparticles and to form an optically clear pressure sensitive adhesive film.

These and other aspects of the present application will be apparent from the detailed description below. In no event, however, should the above summaries be construed as limitations on the claimed subject matter, which subject matter is defined solely by the attached claims, as may be amended during prosecution.

### DETAILED DESCRIPTION

Optically clear PSAs disclosed herein are applicable to a variety of application areas including those in which an optical film is adhered to a substrate, and where heat and humidity resistance are an important consideration, including, for example, electronic display, architectural, transportation, and photonics applications. In some embodiments, the optically clear PSA adheres optical film to optical displays, such as liquid crystal displays, as well as other devices containing optical film. These examples, and the examples discussed below, provide an appreciation of the applicability of the disclosed PSAs, but should not be interpreted in a limiting sense.

Unless otherwise indicated, the term “polymer” will be understood to include polymers, copolymers (e.g., polymers formed using two or more different monomers), oligomers and combinations thereof, as well as polymers, oligomers, or copolymers that can be formed in a blend by, for example, coextrusion or reaction. Both block and random copolymers are included, unless indicated otherwise.

Unless otherwise indicated, the term “alkyl” refers to a straight or branched chain monovalent hydrocarbon radical optionally containing one or more heteroatomic substitutions independently selected from S, O, Si, or N. Alkyl groups generally include those with one to twenty atoms. Alkyl groups may be unsubstituted or substituted with those substituents that do not interfere with the specified function of the composition.

Unless otherwise indicated, “optically clear” refers to an article that has a high light transmittance over at least a portion of the visible light spectrum (about 400 to about 700 nm), and that exhibits low haze.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Weight percent, percent by weight, % by weight, % wt, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an” and “the” encompass embodiments having plural referents, unless the content clearly dictates otherwise. For example, reference to a composition containing “an adhesive layer” encompass embodiments having one, two or more adhesive layers. As used in this specification and the appended claims, the term “or” is generally employed in its sense including “and/or” unless the content clearly dictates otherwise.

This disclosure generally describes pressure sensitive adhesives that include a plurality of nanoparticles. In some embodiments the nanoparticles are surface modified. The pressure sensitive adhesives containing nanoparticles can be optically clear. In many embodiments, the pressure sensitive adhesives containing nanoparticles display improved environmental stability properties relative to similar pressure sensitive adhesives without nanoparticles.

The pressure sensitive adhesives can be formed by combining nanoparticles with a polymer formed from an (meth)acrylate monomer or a mixture of (meth)acrylate monomers and then optionally cross-linking or curing to form the pressure sensitive adhesive film. The pressure sensitive adhesive can also be formed by blending nanoparticles with an acrylic pressure sensitive adhesive solution, followed by coating, drying, and curing or crosslinking. The pressure sensitive adhesive film can be utilized to adhere an optical element such as, for example, an optical film, to another element.

Prior to forming the film, a pressure sensitive adhesive composition containing nanoparticles can be applied to a substrate using a variety of coating methods including, for example, spin coating, web coating, transfer coating, die coating, screen printing, electrospraying, and curtain coating. In some embodiments the substrate is a release liner or includes a release liner. In some embodiments the substrate is or includes an optical film such as a reflective polarizer or mirror film, for example.

The disclosed pressure sensitive adhesive films including nanoparticles can be optically clear, having low haze. In some embodiments, a layer of specified thickness (e.g. 25 micrometer dry thickness) of a disclosed PSA has a haze value of no more than 10%, and is preferably in a range from 0 to 5%, 0 to 3%, or even 0 to 1%. A method for determining haze is described in the Example section below.

The disclosed pressure sensitive adhesive film including nanoparticles can be optically clear, also having a high light transmittance over at least a portion of the visible spectrum. In some embodiments, a layer of specified thickness (e.g. 25 micrometer dry thickness) of a disclosed PSA has a visible light transmittance value, over at least a portion of the visible light spectrum, of at least 50%, and is preferably in a range from 75 to 100%, 85 to 100%, or even 90 to 100%. A method for determining visible light transmittance is described in the Example section below. The disclosed PSA films are capable of exhibiting a substantially colorless appearance, having a substantially uniformly high light transmittance over the visible spectrum.

Disclosed pressure sensitive adhesive films including nanoparticles can possess enhanced physical properties when compared to the same pressure sensitive adhesive film without nanoparticles. A partial listing of enhanced physical properties include increased cohesive strength (Shear test described in the Example section below), increased peel adhesion (180 Degree Peel test described in the Example section below) and/or improved environmental stability (Aging test described in the Example section below).

The pressure sensitive adhesive film can have any useful thickness such as, for example, 5 to 100 micrometers, or 5 to 50 micrometers, or 5 to 25 micrometers.

In some embodiments, the optically clear pressure sensitive adhesive film includes polyacrylate pressure sensitive adhesives. The Pressure-Sensitive Tape Council has defined pressure sensitive adhesives as materials with the following properties: (1) aggressive and permanent tack, (2) adherence with no more than finger pressure, (3) sufficient ability to hold onto an adherent, (4) sufficient cohesive strength, and (5) requires no activation by an energy source. PSAs are normally tacky at assembly temperatures, which is typically room temperature or greater (i.e., about 20° C. to about 30° C. or greater). Materials that have been found to function well as PSAs are polymers designed and formulated to exhibit the requisite viscoelastic properties resulting in a desired balance of tack, peel adhesion, and shear holding power at the assembly temperature. Known polymers for preparing PSAs are natural rubber synthetic rubber- (e.g., styrene/butadiene copolymers (SBR) and styrene/isoprene/styrene (SIS) block copolymers), silicone elastomer-, poly alpha-olefin-, and various (meth)acrylate-(e.g., acrylate, methacrylate, or mixtures thereof) based polymers. Of these, (meth)acrylate-based polymer PSAs are an exemplary class of PSA for use with the disclosed adhesives due to their optical clarity, permanence of properties over time (aging stability), and versatility of adhesion levels, to name just a few of their benefits.

Examples of useful (meth)acrylate monomers for preparing a poly(meth)acrylate pressure sensitive adhesive include specifically, but not exclusively, the following classes:

Class A—includes acrylic acid esters of an alkyl alcohol, the alcohol containing from 2 to 8 or from 4 to 8 carbon atoms and include, for example ethyl acrylate, isopropyl acrylate, isoamyl acrylate, sec-butyl acrylate, n-butyl acrylate, 2-methylbutyl acrylate, 4-methyl-2-pentyl acrylate, 2-(ethyl)hexyl acrylate, isooctyl acrylate and mixtures thereof. Of these, isooctyl acrylate, n-butyl acrylate and 2-(ethyl)hexyl acrylate are exemplary. As homopolymers, these acrylate esters generally have glass transition temperatures of below about 0 degrees Celsius.

Class B—includes (meth)acrylate or other vinyl monomers which, as homopolymers, have glass transition temperatures of greater than about 0 degrees Celsius, for example, methyl acrylate, methyl methacrylate, ethyl methacrylate, isopropyl methacrylate, tert-butyl acrylate, isobornyl (meth)acrylate, butyl methacrylate, vinyl acetate, vinyl esters, and mixtures thereof. The class B monomers can be used in a pressure sensitive adhesive to vary Tg and modulus of the adhesives.

Class C—includes polar monomers such as (meth)acrylic acid; (meth)acrylamides such as N-alkyl (meth)acrylamides and N,N-dialkyl (meth)acrylamides; hydroxy alkyl (meth)acrylates; and N-vinyl lactams such as N-vinyl pyrrolidone and N-vinyl caprolactam; 2-(dimethylamino)ethyl (meth)acrylate, 2-(diethylamino)ethyl (meth)acrylate, and 3-(dimethylamino)propyl (meth)acrylate; acrylonitrile. The polar monomers can be included in the PSA compositions to adjust the Tg or the cohesive strength of the adhesive. Additionally, the polar monomers can function as reactive sites for chemical or ionic crosslinking, if desired.

Class D (Crosslinkers)—In order to increase cohesive strength of the poly(meth)acrylate pressure sensitive adhesives, a crosslinking additive may be incorporated into the PSAs. Two main types of crosslinking additives are exemplary. The first crosslinking additive is a thermal crosslinking additive such as multifunctional aziridine, isocyanate and epoxy. One example of aziridine crosslinker is 1,1′-(1,3-phenylene dicarbonyl)-bis-(2-methylaziridine) (CAS No. 7652-64-4), referred to herein as “Bisamide.” Common polyfunctional isocyanate crosslinkers are trimethylolpropane toluene diisocyanate, toluene diisocyanate, etc. Such chemical crosslinkers can be added into solvent-based PSAs after polymerization and activated by heat during oven drying of the coated adhesive. In another embodiment, chemical crosslinkers, which rely upon free radicals to carry out the crosslinking reaction, may be employed. Reagents such as, for example, peroxides serve as a source of free radicals. When heated sufficiently, these precursors will generate free radicals which bring about a crosslinking reaction of the polymer. A common free radical generating reagent is benzoyl peroxide. Free radical generators are required only in small quantities, but generally require higher temperatures to complete a crosslinking reaction than those required for the bisamide and isocyanate reagents. The second type of crosslinking additive is a photosensitive crosslinker, which is activated by high intensity ultraviolet (UV) light. Two common photosensitive crosslinkers used for acrylic PSAs are benzophenone and copolymerizable aromatic ketone monomers as described in U.S. Pat. No. 4,737,559 (Kellen et al.) Another photocrosslinker, which can be post-added to the solution polymer and activated by UV light is a triazine, for example, 2,4-bis(trichloromethyl)-6-(4-methoxy-phenyl)-s-triazine. These crosslinkers are activated by UV light generated from sources such as medium pressure mercury lamps or a UV blacklight. Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysilane, vinyltriethoxysilane, vinyltrimethoxysilane, vinyltriphenoxysilane, and the like, are also useful crosslinking agents. Crosslinking may also be achieved using high energy electromagnetic radiation such as gamma or e-beam radiation. In this case, no crosslinker may be required.

Class E (Additives)—Following copolymerization, other additives may be blended with the resultant poly(meth)acrylate pressure sensitive adhesives. For example, compatible tackifiers and/or plasticizers may be added to aid in optimizing the ultimate modulus, Tg, tack and peel properties of the PSA. The use of such tack-modifiers is known. Examples of useful tackifiers include, but are not limited to, rosin, rosin derivatives, polyterpene resins, coumarone-indene resins, and the like. Plasticizers, which may be added to the disclosed adhesives, may be selected from a wide variety of commercially available materials. In each case, the added plasticizer should be compatible with the PSA. Representative plasticizers include polyoxyethylene aryl ether, dialkyl adipate, 2-ethylhexyl diphenyl phosphate, 4-(t-butyl)phenyl diphenyl phosphate, bis(2-ethylhexyl) adipate, toluenesulfonamide, dipropylene glycol dibenzoate, polyethylene glycol dibenzoate, polyoxypropylene aryl ether, bis(butoxyethoxyethyl) formal, and bis(butoxyethoxyethyl) adipate.

The disclosed PSAs can be prepared by solution polymerization, emulsion polymerization, bulk polymerization, and the like. Adhesive properties of the pressure sensitive adhesives are to a great extent influenced by the compositions and ratios of the monomers chosen for copolymerization as described above in the Classes A to C. The PSA properties can be further modified, by adding crosslinker and additive as described above in the Classes D and E.

In some embodiments, an optically clear pressure sensitive adhesive film is formed by combining nanoparticles with a pressure sensitive adhesive comprising butyl acrylate and acrylic acid, and forming an optically clear pressure sensitive adhesive film. In some embodiments, an optically clear pressure sensitive adhesive film is formed by combining nanoparticles with a pressure sensitive adhesive comprising 90-95% wt butyl acrylate and 5-10% wt acrylic acid, and coating and drying the composition to form an optically clear pressure sensitive adhesive film. In some embodiments, an optically clear pressure sensitive adhesive film is formed by combining nanoparticles with a pressure sensitive adhesive comprising butyl acrylate, methyl acrylate and acrylic acid, and forming an optically clear pressure sensitive adhesive film. In some embodiments, an optically clear pressure sensitive adhesive film is formed by combining nanoparticles with a pressure sensitive adhesive comprising 55-65% wt butyl acrylate, 35-45% wt methyl acrylate, and 1-5% wt acrylic acid, and coating and drying the composition to form an optically clear pressure sensitive adhesive film. In many embodiments, a cross-linker such as, for example, bisamide is added to the compositions.

Nanoparticles are included in the optically clear pressure sensitive adhesive film in any useful amount. The pressure sensitive adhesive film can include from 1 to 70% wt nanoparticles, or from 5 to 70% wt, or from 10 to 60% wt, or from 30 to 60% wt. It is understood that the nanoparticle loading on a % wt basis will be affected by the density of the nanoparticles. The nanoparticles can be any useful size such as, for example, having a mean diameter of 3 to 100 nanometers, or 5 to 75 nanometers, or 5 to 50 nanometers, or 5 to 30 nanometers. The nanoparticles can be formed of any useful material such as, for example, a metal oxide. In many embodiments, the nanoparticles are surface-modified.

The surface-modified nanoparticles can be selected such that the composition formed therewith is free from a degree of particle agglomeration or aggregation that would interfere with the desired properties of the composition. The surface-modified nanoparticles can be selected to be compatible with the pressure sensitive adhesive composition.

The surface-modified nanoparticles have surface groups that modify the solubility characteristics of the nanoparticles. The surface groups are selected to render the particle compatible with the pressure sensitive adhesive composition. When the composition is polymerizable, for example, the surface groups can be selected to associate or react with at least one component of the pressure sensitive adhesive composition to become part of the polymer network of the pressure sensitive adhesive composition.

The surface groups are present on the surface of the particle in an amount sufficient to provide surface-modified nanoparticles that are capable of being subsequently dispersed in the pressure sensitive adhesive composition without aggregation. The surface groups preferably are present in an amount sufficient to form a monolayer, preferably a continuous monolayer, on the surface of the particle.

Surface modifying groups may be derived from surface modifying agents. Schematically, surface modifying agents can be represented by the formula A-B, where the A group is capable of attaching to the surface of the particle and the B group is a compatibilizing group that may be reactive or non-reactive with a component of the composition. Compatibilizing groups can be selected to render the particle relatively more polar, relatively less polar or relatively non-polar.

Suitable classes of surface-modifying agents include, e.g., silanes, organic acids organic bases, and alcohols. Particularly useful surface-modifying agents include silanes. Examples of useful silanes include organosilanes including, e.g., alkylchlorosilanes, alkoxysilanes, e.g., methyltrimethoxysilane, methyltriethoxysilane, ethyltrimethoxysilane, ethyltriethoxysilane, n-propyltrimethoxysilane, n-propyltriethoxysilane, isopropyltrimethoxysilane, isopropyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltriethoxysilane phenyltriethoxysilane, phenyltrimethoxysilane, vinyltrimethoxysilane, vinyidimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltris(t-butoxy)silane, vinyltris(isobutoxy) silane, vinyltris(isopropenoxy)silane and vinyltris(2-methoxyethoxy)silane; trialkoxyarylsilanes; isooctyltrimethoxy-silane; N-(3-triethoxysilylpropyl) methoxyethoxyethoxy ethyl carbamate; N-(3-triethoxysilylpropyl) methoxyethoxyethoxyethyl carbamate; silane functional (meth)acrylates including, e.g., 3-(methacryloyloxy)propyltrimethoxysilane, 3-acryloyloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy)methyltriethoxysilane, 3-(methacryloyloxy)methyltrimethoxysilane, 3-(methacryloyloxy)propyldimethylethoxysilane, 3-(methacryloyloxy)propenyltrimethoxysilane and 3-(methacryloyloxy)propyltrimethoxysilane; polydialkylsiloxanes including, e.g., polydimethylsiloxane, arylsilanes including, e.g., substituted and unsubstituted arylsilanes, alkylsilanes including, e.g., substituted and unsubstituted alkyl silanes including, e.g., methoxy and hydroxy substituted alkyl silanes, and combinations thereof.

Methods of surface-modifying silica using silane functional (meth)acrylates are described, e.g., in U.S. Pat. No. 4,491,508 (Olson et al.,) and U.S. Pat. No. 4,455,205 (Olson et al.,) U.S. Pat. No. 4,478,876 (Chung) and U.S. Pat. No. 4,486,504 (Chung) and U.S. Pat. No. 5,258,225 (Katsamberis), all of which are incorporated herein by reference.

Useful organic acid surface-modifying agents include, e.g., oxyacids of carbon (e.g., carboxylic acid), sulfur and phosphorus, and combinations thereof. Representative examples of polar surface-modifying agents having carboxylic acid functionality include CH₃O(CH₂CH₂O)₂CH₂COOH (hereafter MEEAA) and 2-(2-methoxyethoxy)acetic acid having the chemical structure CH₃OCH₂CH₂OCH₂COOH (hereafter MEAA) and mono(polyethylene glycol) succinate.

Representative examples of non-polar surface-modifying agents having carboxylic acid functionality include octanoic acid, dodecanoic acid and oleic acid.

Examples of suitable phosphorus containing acids include phosphonic acids including, e.g., octylphosphonic acid, laurylphosphonic acid, decylphosphonic acid, dodecylphosphonic acid and octadecylphosphonic acid.

Useful organic base surface-modifying agents include, e.g., alkylamines including, e.g., octylamine, decylamine, dodecylamine and octadecylamine.

Examples of other useful non-silane surface modifying agents include acrylic acid, methacrylic acid, beta-carboxyethyl acrylate, mono-2-(methacryloyloxyethyl) succinate, and combinations thereof. A useful surface modifying agent that imparts both polar character and reactivity to the nanoparticles is mono(methacryloyloxypolyethyleneglycol) succinate.

Examples of suitable surface-modifying alcohols include, e.g., aliphatic alcohols including, e.g., octadecyl, dodecyl, lauryl and furfuryl alcohol, alicyclic alcohols including, e.g., cyclohexanol and aromatic alcohols including, e.g., phenol and benzyl alcohol, and combinations thereof.

A variety of methods are available for modifying the surface of nanoparticles including, e.g., adding a surface modifying agent to nanoparticles (e.g., in the form of a powder or a colloidal dispersion) and allowing the surface modifying agent to react with the nanoparticles. Other useful surface modification processes are described in, e.g., U.S. Pat. No. 2,801,185 (Iler) and U.S. Pat. No. 4,522,958 (Das et al.,) which are incorporated herein by reference.

The nanoparticles used in the disclosed PSAs are nonabsorbing (at wavelengths of interest) metal oxide or semiconductor particles. Examples of suitable nanoparticles include, but are not limited to, SiO₂, Al₂O₃, ZrO₂, TiO₂, V₂O₅, ZnO, SnO₂, ZnS, and combinations thereof. Additionally the particles can include species that have a core of one material on which is deposited a material of another type. The nanoparticles have an average particle diameter less than about 100 nm, or no greater than about 50 nm. The nanoparticles can be any useful size, e.g., having a mean diameter of 3 to 100 nanometers, or 5 to 75 nanometers, or 5 to 50 nanometers, or 5 to 30 nanometers. If the nanoparticles are aggregated, the maximum cross sectional dimension of the aggregated particle is preferably within any of these ranges.

Useful surface-modified zirconia nanoparticles include a combination of oleic acid and acrylic acid adsorbed onto the surface of the particle. One useful method of surface modification of zirconia nanoparticles is described in U.S. Pat. No. 6,416,838 (Arney et al.), which is incorporated by reference herein.

Useful surface-modified silica nanoparticles include silica nanoparticles surface-modified with silane surface modifying agents including, e.g., acryloyloxypropyl trimethoxysilane, 3-methacryloyloxypropyltrimethoxysilane, 3-mercaptopropyltrimethoxysilane, n-octyltrimethoxysilane, isooctyltrimethoxysilane, phenyltrimethoxysilane, and combinations thereof. Silica nanoparticles can be treated with a number of surface modifying agents including, e.g., alcohol, organosilane including, e.g., alkyltrichlorosilanes, trialkoxyarylsilanes, trialkoxy(alkyl)silanes, and combinations thereof and organozirconates, organotitanates and mixtures thereof.

The nanoparticles may be in the form of a colloidal dispersion. Examples of useful commercially available unmodified silica starting materials include nano-sized colloidal silicas available under the product designations NALCO 1040, 1050, 1060, 2326, 2327, and 2329 colloidal silica from Nalco Chemical Co., Naperville, Ill. In some embodiments, the pressure sensitive adhesive film can include modified silica nanoparticles from 5 to 60% wt, or from 10 to 50% wt, or from 20 to 50% wt.

Other useful metal oxide colloidal dispersions include colloidal zirconium oxide, suitable examples of which are described in U.S. Pat. No. 5,037,579 (Matchett), which is incorporated herein by reference, and colloidal titanium oxide, useful examples of which are described in PCT Publication No. WO 00/06495 entitled, “Nanosize Metal Oxide Particles for Producing Transparent Metal Oxide Colloids and Ceramers,” (Arney et al.) filed Jul. 30, 1998, and incorporated herein by reference.

Various methods may be employed to combine the surface-modified nanoparticles and the pressure sensitive adhesive composition. In one method, a colloidal dispersion of surface-modified nanoparticles and pressure sensitive adhesive are combined. Solvent present in the composition is then removed, leaving the surface-modified nanoparticles dispersed in the pressure sensitive adhesive composition. The solvent may be removed by evaporation including, e.g., distillation, rotary evaporation or oven drying. Optionally, for some colloidal dispersions, e.g., aqueous colloidal dispersions, prior to addition of the pressure sensitive adhesive composition, a cosolvent (e.g., methoxy-2-propanol or N-methylpyrrolidone) may be added to the colloidal dispersion to assist removal of water. After the pressure sensitive adhesive composition is added, the water and cosolvent can be removed.

Another method for incorporating colloidal dispersions of surface-modified nanoparticles into a pressure sensitive adhesive composition includes drying the colloidal dispersion of surface-modified nanoparticles to a powder, followed by addition of the pressure sensitive adhesive composition or at least one component of the pressure sensitive adhesive composition into which the nanoparticles are to be dispersed. The drying step may be accomplished by conventional means such as oven drying or spray drying. The surface-modified nanoparticles can have a sufficient amount of surface groups to prevent irreversible agglomeration or irreversible aggregation upon drying. The drying time and the drying temperature can be minimized for nanoparticles having less than 100% surface coverage.

The optically clear pressure sensitive adhesive films described herein can be used to adhere an optical film to another optical element such as, for example, another optical film or a substrate, whether made of glass, polymer, or other material.

A variety of materials and methods can be used to make the optical film elements described herein. Any polymeric material capable of possessing the optical properties described herein is contemplated. A partial listing of these polymers include, for example, polyolefins, polyacrylates, polyesters, polycarbonates, fluoropolymers, polyimides, and the like. One or more polymers can be combined to form the polymeric optical film.

Polyolefins include for example: cyclic olefin polymers such as, for example, polycyclohexane, polynorbornene and the like; polypropylene; polyethylene; polybutylene; polypentylene; and the like. A specific polybutylene is poly(1-butene). A specific polypentylene is poly(4-methyl-1-pentene). The polymeric material described herein can be capable of forming a crystalline or semi-crystalline material. The polymeric material described herein may also be capable of forming a non-crystalline material.

Polyesters can include, for example, poly(ethylene terephthalate) or poly(ethylene naphthalate). The polymeric material described herein can be capable of forming a crystalline or semi-crystalline material. The polymeric material described herein may also be capable of forming a non-crystalline material.

Polyacrylates include, for example, acrylates, methacrylates and the like. Examples of specific polyacrylates include poly(methyl methacrylate), and poly(butyl methacrylate).

Fluoropolymer specifically includes, but is not limited to, poly(vinylidene fluoride).

The optical film with the PSA described herein can be used with a variety of other components and films that enhance or provide other properties to an optical element. Such components and films include, for example, brightness enhancement films, retardation plates including quarter-wave plates and films, multilayer or continuous/disperse phase reflective polarizers, metallized back reflectors, prismatic back reflectors, diffusely reflecting back reflectors, multilayer dielectric back reflectors, and holographic back reflectors. In some embodiments, the optical film is or includes an optical compensation film.

The PSA films disclosed herein can take the physical form of a simple layer with substantially planar opposed major surfaces. Alternatively, they can be made in the form of a layer with a structured (e.g., grooved) major surface so that as the adhesive is applied to the surface of an optical element, air can more easily escape or bleed out from between the PSA and the surface of the optical element during application. Sufficient pressure is applied to collapse the features of the structured surface so that after application, the PSA film has substantially planar opposed major surfaces, and air entrapment between the PSA and optical element is avoided. Such structured surfacing of adhesive films is disclosed, for example, in U.S. Pat. No. 6,123,890 (Mazurek et al.), and U.S. Patent Application Publication US2003/0082326 (Yang et al.), which are incorporated herein by reference.

In most cases, the optically clear PSA films disclosed herein are substantially colorless, i.e., they have low haze and a uniformly high transmission over substantially the entire visible spectrum. In some cases, however, the optically clear PSA films can comprise one or more dyes, pigments, or colorants to provide the PSA film with a desired color (e.g., blue, green, or red) or to adjust the color of the PSA film to a desired color point. Preferably, such dyes, pigments, or other colorants are chosen to maintain the low haze properties of the PSA film.

### EXAMPLES

Methods

180 degree Peel Adhesion

Peel adhesion is the force required to remove a coated flexible sheet material from a test panel measured at a specific angle and rate of removal. In the example this force is expressed in ounce per 0.5 inch width of coated sheet. The procedure follows:

1. A 0.5 inch width of the coated sheet is applied to the horizontal surface of a clean test glass pate with at least 12.7 linear cm in firm contact. A hard rubber roller is used to apply the strip.

2. The free end of the coated strip is doubled back nearly touching itself, so the angle of removal is 180 degrees. The free end is attached to the adhesion tester scale.

3. The glass test plate is clamped in the jaws of the tensile testing machine, which is capable of moving the plate away from the scale at a constant rate of 12 inch/min.

4. The force in ounces is recorded as the tape is peeled from the glass surface. The average value of the measured force over a five second time interval is then computed and recorded.

Shear Holding Strength

The shear holding strength is a measure of the cohesive strength of an adhesive. It is based upon the amount of force required to pull an adhesive strip from a standard flat stainless steel surface at a specified temperature in a direction parallel to the surface to which it has been affixed with pressure. Shear holding strength is reported as a time in units of minutes. The tests were conducted on an adhesive coated strip applied to a stainless steel panel such that a 0.5 inch by 0.5 inch portion of each strip was in firm contact with the panel with one end portion of the tape being free. The panel with coated strip attached was held in a rack such that the panel forms an angle of 178 degrees with the extended tape free end, which is then tensioned by application of a force of one kilogram applied as a hanging weight from the free end of the coated strip. The time elapsed for each tape example to separate from the test panel is recorded as the shear strength. The shear tests described herein were carried out in a 70° C. oven.

Aging Test

Several different protocols have been used for testing the aging properties of coated laminate structures. One protocol was carried out by placing the laminate in a dry oven at a temperature of 80° C. or 90° C. with a specified aging time, and is called the “80° C. or 90° C. test.” Another was carried out by placing the laminate in an oven with a controlled temperature and humidity of 60° C., 90% relative humidity or 80° C., 90% relative humidity for a specified time and is called the “60° C./90% RH or 80° C./90% RH test.” Results of these testing protocols are determined by visual observation. The data are reported as: “Good” if the laminate retains its optical clarity, that is, exhibits no bubble formation or delamination in the adhesive bond area; “Marginal” if small bubbles (<25 micrometers, not visible to the naked eye) are formed in the bond area; and “Poor” if larger bubbles (>25 micrometers, visible to the naked eye) are formed in the bond area.

In the test, an adhesive coated optical film was laminated to a 2 inch by 3 inch microscope glass or a plastic substrate (such as a 3 millimeter thick PMMA plate from Plaskolite Inc, Columbus, Ohio). The laminates were then stored in a constant temperature and humidity room (23° C./50% RH) for 24 hours before putting them in a specified environmental chamber for aging.

Materials

“NALCO 2327” is 20 nm silica colloidal dispersion available from Nalco Chemical Company, Naperville, Ill.
“AA” is acrylic acid available from Aldrich Chemical Company, Milwaukee Wis.
“MA” is methyl acrylate available from Aldrich Chemical Company, Milwaukee Wis.
“BA” is butyl acrylate available from Aldrich Chemical Company, Milwaukee Wis.
“Vazo 67” initiator is 2-2′-azobis-(2-methylbutyronitrile), available from E. I. DuPont de Nemour & Co., Wilmington, Del.
“Phenyltrimethoxysilane” is available from Aldrich Chemical Company, Milwaukee Wis.
“1-methoxy-2-propanol” is available from Aldrich Chemical Company, Milwaukee Wis.
“Bisamide” is 1,1′-(1,3-phenylene dicarbonyl)-bis-(2-methylaziridine), CAS No. 7652-64-4, available in solution under the name HX-752 Dynamar™ Brand Curative from 3M Company, St. Paul, Minn.
“Primed PET Film” is a polyethylene terephthalate film (2 mil) known as Melinex 453, available from DuPont Teijin films.
“Sanritz Polarizer” is a Sanritz Polarizer 5518-SF film, available from Sanritz Co., Japan.
“Polymethylmethacrylate Sheet or PMMA Plate” refers to an Optix acrylic plate of 3.0 millimeter thick polymethylmethacrylate available from Plaskolite Inc., Columbus, Ohio.
“Teijin A31 Release Liner” is available from Teijin Chemical Company, Japan.
“Glass Slide” is a 3″×2″×1 mm Corning No. 2947 MicroSlides available from Corning Glass Works, Corning, N.Y.
   Surface-modified Nanoparticle Preparation

To a one liter reaction vessel equipped with a stir bar was added 250 g of NALCO 2327 silica sol (20 nm silica particles, 41.1% wt in water). Over the course of 45 minutes, 12.63 grams of phenyltrimethoxysilane in 400 g of 1-methoxy-2-propanol was added to the stirring silica sol. The ratio of phenyltrimethoxysilane to silica particle is 0.62 mmol/1.0 gram silica. The reaction vessel was sealed and heated at 90° C. for 20 hours. The water was then removed for the vessel to give phenylsilane treated 20 nm silica particles in 1-methoxy-2-propanol. The weight percent of treated silica in solvent was determined by gravimetric analysis to be 42% wt. This solution was filtered through a 0.2 micrometer filter to remove any dust particles. In the following examples, silica refers to surface-modified silica nanoparticles.

Preparation of BA/AA (92.5/7.5) Solution PSA

Into a glass reaction vessel were placed Vazo-67 initiator (0.15 grams), BA (92.5 grams), AA (7.5 grams), and acetone (233 grams). The resulting solution was degassed with nitrogen bubbling for 10 minutes, and the vessel was sealed and spun in a 60° C. water bath for 24 hours to yield a viscous solution of around 29% wt solids.

Preparation of BA/MA/AA (58/40/2) Solution PSA

Into a glass reaction vessel were placed Vazo-67 initiator (0.15 grams), BA (58 grams), MA (40 grams), AA (2 grams), and acetone (233 grams). The resulting solution was degassed with nitrogen bubbling for 10 minutes, and the vessel was sealed and spun in a 60° C. water bath for 24 hours to yield a viscous solution of around 29% wt solids.

Effect of Silica Nanoparticle Loading on PSA Properties

PSAs in Table 1 were formed by compounding the BA/AA (92.5/7.5) PSA solution, and 0.10% wt bisamide, based on the solid weight of the PSA solution, with the % wt silica loading indicated in Table 1 below. The compounded solutions were coated onto a primed PET film at a dry thickness of 1 mil and dried at 70° C. for 10 minutes. The samples were then tested for 180 degree peel adhesion on glass at constant temperature and humidity (23° C. and 50% RH) and for 70° C. Shear as described above.

TABLE 1

| BA/AA | | |
|---|---|---|
| (92.5/7.5)PSA + 0.1% wt | 180 Degree Peel Adhesion | 70° C. Shear |
| Bisamide + % wt Silica | (oz/0.5 in) | (min) |
| 0% Silica | 21.6 | 500 |
| 3.5% Silica | 22.8 | 3000 |
| 6.9% Silica | 23.9 | >10,000 |
| 11.5% Silica | 25.9 | >10,000 |
| 23.0% Silica | 27.8 | >10,000 |
| 34.5% Silica | 27.3 | >10,000 |
| 46.0% Silica | 25.5 | >10,000 |

These results indicate that PSA properties (adhesion and shear) increase with increasing silica particle loading.
% Transmittance and % Haze Measurement

A PSA coating at a dry thickness of 25 micrometer was laminated to a microscope glass slide. Table 2 below reports % transmittance and % haze of the laminate measured by a BYK Gardner TCS Plus™ Spectrophotometer Model 8870, sold by BYK Gardner, USA, where TCS™ refers to The Color Sphere™. The percent transmittance, which is not adjusted to remove the effect of front and rear Fresnel surface reflections, was measured from 380 to 720 nm in 10 nm increments. The value at 550 nm wavelength is recorded in Table 2 below. For the PSA coatings of Examples 1 and 2, the percent transmittance was substantially constant over the measured range.

Percent Haze was also measured on the Model 8870 TCS Plusm Spectrophotometer, calibrated in accordance with the operating manual. This instrument uses a tungsten-halogen lamp in combination with a six-inch integrating sphere to provide diffuse illumination to the sample. The illuminated area of the sample is a circle 25 millimeters in diameter. An 8 degree “viewing geometry” is used by the instrument, and the light transmitted by the sample is detected with a detector unit comprising a high resolution, full-dispersion, holographic grating polychromator fitted with a silicon diode array. This detector unit measures light intensity over the range from 380 nm to 720 nm in 10 nm increments. For the haze measurements reported herein, two intermediate measurements are made, one for total luminous transmittance (TLT) and one for diffuse luminous transmittance (DLT). The ratio DLT/TLT provides a measurement of the transmitted (forward scattering) haze of the sample. One of ordinary skill in the optical measuring arts will appreciate that the foregoing measuring conditions need not be rigidly followed in order to obtain an accurate measurement of % haze, that reasonable deviations from such conditions are acceptable, and that alternative methods of measuring % haze are also possible.

TABLE 2

| | | | % |
|---|---|---|---|
| Example | Adhesive Composition | % Transmittance | Haze |
| Control | Microscope glass slide only | 92.43 | 0.5 |
| 1 | BA/AA (92.5/7.5) PSA/Silica | 92.95 | 0.6 |
| | Nano-particle (77/23) | | |
| 2 | BA/MA/AA (58/40/2) PSA/Silica | 92.92 | 0.7 |
| | Nano-particle (80/20) | | |

Effect of Silica Nanoparticle Loading on PSA Heat and Humidity Stability (Aging Test)

PSAs were formed by compounding the adhesive components, treated silica nanoparticles, and bisamide according to Tables 3 and 4 below. These compounded solutions were coated onto a Teijin A31 release liner to a dry thickness of 25 micrometers and dried at 70° C. for 10 minutes.

Adhesive samples in Table 3 were laminated to a Sanritz polarizer and glass slide (washed 3 times with isopropyl alcohol), dwelled overnight in a constant temperature and humidity (23 degrees Celsius and 50% RH) room and then placed into a 60° C./90% relative humidity environment and aged 26 days.

Adhesive samples in Table 4 were laminated to a primed PET film and PMMA plate, dwelled overnight in a constant temperature and humidity (23° C. and 50% RH) room and then placed into a 90° C. environment and aged 18 days or placed into an 80° C./90% relative humidity environment and aged 18 days. The samples were then visually inspected for delamination or bubbling.

TABLE 3

| PSA Composition | | | Aging Conditions |
|---|---|---|---|
| | Silica | Bisamide | 60° C./90% RH |
| Adhesive | % wt | % wt | (26 days) |
| BA/AA (92.5/7.5) | 0 | 0.1 | 30% of polarizer film delam- |
| | | | inated from glass surface |
| BA/AA (92.5/7.5) | 23 | 0.1 | No Delamination |
| BA/AA (92.5/7.5) | 46 | 0.1 | No Delamination |
| BA/MA/AA (58/40/2) | 0 | 0.15 | 90% of polarizer film delam- |
| | | | inated from glass surface |
| BA/MA/AA (58/40/2) | 20 | 0.15 | No Delamination |
| BA/MA/AA (58/40/2) | 40 | 0.15 | No Delamination |

The results indicate that incorporation of silica nano-particles in PSA improved heat and humidity resistance in the polarizer/PSA/glass construction.

TABLE 4

| PSA Composition | | | Aging Conditions | |
|---|---|---|---|---|
| | Silica | Bisamide | 90° C. | 80° C./90% RH |
| Adhesive | % wt | % wt | (18 days) | (18 days) |
| BA/MA/AA (58/40/2) | 0 | 0.15 | Poor | Poor |
| BA/MA/AA (58/40/2) | 20 | 0.15 | Marginal | Marginal |
| BA/MA/AA (58/40/2) | 40 | 0.15 | Good | Good |

The results indicate that incorporation of silica nano-particles in PSA improved heat and humidity resistance in the construction of PET/PSA/PMMA.
All of the PSA films reported in the above Examples section (including all those listed in Tables 1-4) were optically clear and substantially colorless before and after the indicated tests, even though some exhibited better peel adhesion than others, and some exhibited delamination or bubble formation after the aging tests.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A pressure sensitive adhesive film comprising:
a pressure sensitive adhesive formed by polymerizing a (C₁-C₈)alkyl (meth)acrylate monomer; and
a plurality of surface modified nanoparticles dispersed in the pressure sensitive adhesive, wherein the pressure sensitive adhesive film is optically clear.

2. A pressure sensitive adhesive film according to claim 1 wherein the surface modified nanoparticles comprise 5 to 75 nm silica nanoparticles.

3. A pressure sensitive adhesive film according to claim 1 wherein the surface modified nanoparticles comprise zirconia nanoparticles.

4. A pressure sensitive adhesive film according to claim 1 wherein the pressure sensitive adhesive comprises (meth)acrylic acid.

5. A pressure sensitive adhesive film according to claim 1 wherein the pressure sensitive adhesive film comprises 5 to 60% wt surface modified nanoparticles.

6. A pressure sensitive adhesive film according to claim 1 wherein the pressure sensitive adhesive film further comprises a crosslinking agent.

7. A pressure sensitive adhesive film according to claim 1 wherein the pressure sensitive adhesive is formed by polymerizing a (C₁-C₄)alkyl (meth)acrylate monomer.

8. A pressure sensitive adhesive film according to claim 1 wherein the pressure sensitive adhesive is formed by polymerizing a butyl acrylate monomer and acrylic acid.

9. A pressure sensitive adhesive film according to claim 1 wherein the pressure sensitive adhesive is formed by polymerizing a butyl acrylate monomer, a methyl acrylate monomer, and acrylic acid.

10. A pressure sensitive adhesive article comprising:
a substrate;
a pressure sensitive adhesive film formed by polymerizing a (C₁-C₈)alkyl (meth)acrylate monomer, disposed on the substrate; and
a plurality of surface modified nanoparticles disposed in the pressure sensitive adhesive, wherein the pressure sensitive adhesive film is optically clear.

11. The pressure sensitive adhesive article of claim 10, wherein the pressure sensitive adhesive film has a haze value in a range of 0 to 5%.

12. A pressure sensitive adhesive article according to claim 10 wherein the pressure sensitive adhesive film has a haze value of 0 to 3%.

13. A pressure sensitive adhesive article according to claim 10 wherein the pressure sensitive adhesive film has a 70° C. shear value of 10,000 min or greater.

14. A pressure sensitive adhesive article according to claim 10 wherein the pressure sensitive adhesive film does not delaminate from a glass substrate when aged at 60° C. and 90% relative humidity for 26 days.

15. A pressure sensitive adhesive article according to claim 10 wherein the substrate comprises an optical film.

16. A pressure sensitive adhesive article according to claim 10 wherein the substrate comprises a release liner.

17. A method of forming a pressure sensitive adhesive film comprising the steps of:
polymerizing a (C₁-C₈)alkyl (meth)acrylate monomer to form a pressure sensitive adhesive composition; and
combining the pressure sensitive adhesive composition with a plurality of surface modified nanoparticles and to form an optically clear pressure sensitive adhesive film.

18. A method of forming a pressure sensitive adhesive film according to claim 17 further comprising the step of crosslinking the optically clear pressure sensitive adhesive film to form a crosslinked optically clear pressure sensitive adhesive film.

19. A method of forming a pressure sensitive adhesive film according to claim 17 further comprising the step of disposing the optically clear pressure sensitive adhesive film on an optical film to form an optically clear pressure sensitive adhesive laminate.

20. A method of forming a pressure sensitive adhesive film according to claim 19 further comprising:
applying the optically clear pressure sensitive adhesive laminate to an optical element to form an optical article.
